(19) United States
(12) Patent Application Publication
(10) Pub. No.: US 2026/0126314 A1
(43) Pub. Date: May 7, 2026

(54) METHOD FOR OPERATING AN ULTRASONIC FLOWMETER AND ULTRASONIC FLOWMETER

(71) Applicant: KROHNE AG, Basel (CH)

(72) Inventors: Willemijn SCHIPPER, Papendrecht (NL); Eugene VAN DIJK, Spijkenisse (NL)

(73) Assignee: KROHNE AG, Basel (CH)

(21) Appl. No.: 19/381,701

(22) Filed: Nov. 6, 2025

(30) Foreign Application Priority Data
Nov. 6, 2024 (DE) 10 2024 132 291.8

(51) Int. Cl. G01F 1/667

(52) U.S. Cl. CPC G01F 1/668

(57) ABSTRACT

A method for operating an ultrasonic flowmeter and an ultrasonic flowmeter are provided. The ultrasonic flowmeter comprises at least one emitting ultrasonic transducer for transmitting ultrasonic signals and at least one receiving ultrasonic transducer for receiving. A control and evaluation unit actuates the emitting ultrasonic transducer such that it emits the ultrasonic signal, the receiving ultrasonic transducer receives the emitted ultrasonic signal and the control and evaluation unit determines at least one indirect value for the flow rate of the medium through the measuring tube by evaluating emitted and received ultrasonic signals. A constant measurement quality is achieved by the control and evaluation unit adapting an ultrasonic signal frequency of the emitted ultrasonic signal such that a change in an opening angle of the sound beam of the ultrasonic signal caused by a change in the value of the sound velocity of the medium is at least partially compensated.

This nonprovisional application claims priority under 35 U.S.C. § 119 (a) to German Patent Application No. 10 2024 132 291.8, which was filed in Germany on Nov. 6, 2024, and which is herein incorporated by reference.

### BACKGROUND OF THE INVENTION

### Field of the Invention

The present invention relates to a method for operating an ultrasonic flowmeter for measuring the flow rate through a measuring tube through which a medium flows, wherein the ultrasonic flowmeter comprises at least one emitting ultrasonic transducer for transmitting ultrasonic signals and at least one receiving ultrasonic transducer for receiving ultrasonic signals and a control and evaluation unit, wherein the ultrasonic transducers are arranged such that they implement an ultrasonic measuring path in the medium and wherein the control and evaluation unit controls the emitting ultrasonic transducer such that it emits an ultrasonic signal, that they implement an ultrasonic measuring path in the medium, and wherein the control and evaluation unit controls the emitting ultrasonic transducer such that it emits an ultrasonic signal, the receiving ultrasonic transducer receives the emitted ultrasonic signal and the control and evaluation unit determines at least one indirect value for the flow rate of the medium through the measuring tube by evaluating emitted ultrasonic signals and received ultrasonic signals. Furthermore, the invention also relates to such an ultrasonic flowmeter.

### Description of the Background Art

Flow measurement using ultrasonic waves is known. Regardless of the exact measuring method used (for example transit time measurement, transit time difference measurement (with the flow direction and against the flow direction), frequency measurement/Doppler effect), flow measurement is always based on the entrainment of ultrasonic waves in the medium flowing through the measuring tube, the flow velocity of which is to be determined.

In the vast majority of ultrasonic flowmeters, the characteristic dimensions of the measuring tube (in the case of the usual round measuring tubes, the measuring tube diameter) are significantly larger than the wavelength of the ultrasonic signal used for measurement, so that the ultrasonic waves propagating in the medium can be interpreted as free-space waves. It is known that the shape of the emitted ultrasonic signals can be influenced by various measures, for example by determining the geometry of the ultrasonic transducer. In this context, the opening angle of a sound beam of the emitted ultrasonic signal is often referred to. If the maximum sound pressure is present in a main radiation direction of the emitting ultrasonic transducer, then it is determined at which angle deviating from the main radiation direction, for example, only half the sound pressure is present. This angle is then taken as the opening angle of the sound beam, although sound pressure can of course still be detected at opening angles beyond this. In any case, the opening angle of the sound beam of the ultrasonic signal is a suitable measure of the focus of the ultrasonic signal.

A small opening angle of the sound beam of the ultrasonic signal is advantageous in terms of achieving a good signal-to-noise ratio. In ultrasonic flowmeters with several implemented measuring paths with several ultrasonic transducer pairs, small opening angles of the sound beams of the ultrasonic signals can be used to avoid or at least reduce mutual interference between the ultrasonic transducers. If there are installation situations in which installations protrude into the measuring space crossed by the measuring path (other sensors, agitators, etc.), small opening angles also avoid or reduce interfering reflections. On the other hand, the sound beam must have a sufficiently large opening angle so that the ultrasonic signal also reliably covers a sufficiently large reception area.

### SUMMARY OF THE INVENTION

It is therefore an object of the present invention to further develop a method for operating the ultrasonic flowmeter and to provide a corresponding ultrasonic flowmeter in such a way that consistent measurement quality is ensured even in the case of highly variable measurement situations.

In an example of the method for operating an ultrasonic flowmeter, the derived object can be first achieved by the control and evaluation unit controlling the emitting ultrasonic transducer in such a way that the emitted ultrasonic signal is emitted at a defined ultrasonic signal frequency, so that at a defined value of the sound velocity of the medium flowing in the measuring tube, the ultrasonic signal is emitted with a defined opening angle of an sound beam of the ultrasonic signal.

These defined conditions and settings of the ultrasonic flowmeter often correspond to the conditions and specifications underlying the specification of the ultrasonic flowmeter for a determined medium, for example water. In many processes in which ultrasonic flowmeters are used, there is little variation in the process conditions.

The present invention is based on observations made in connection with gaseous media whose composition is subject to change, which can have a considerable effect on the ultrasonic signal, in particular on the opening angle of the sound beam of the emitted ultrasonic signal and thus on the measurement. Particularly when working with light gases (e.g. hydrogen), considerable differences in the propagation of sound waves can occur when the gas is changed (e.g. to natural gas) or the gas composition changes. The reason for this is that the sound velocity in a gaseous medium is inversely proportional to the square root of the molar mass of its molecules. For example, nitrogen has a sound velocity of around 337 m/s at 0° C. and at normal pressure, while hydrogen has a sound velocity of around 1261 m/s under the same conditions.

While the change in sound velocity in the usual transit time difference measurement has practically no influence on the determination of the flow velocity of the medium and thus on the flow measurement value, it has been recognized that significant changes in the sound velocity have a considerable effect on the opening angle of the sound beam of the ultrasonic signal excited at the defined ultrasonic signal frequency.

Such a change in the opening angle of the sound beam can significantly limit the measurement quality and is therefore undesirable.

In connection with the invention, however, it has also been recognized that the opening angle of the sound beam of the emitted ultrasonic signal can also be influenced by changing the ultrasonic signal frequency. According to the invention, it is therefore provided that the control and evaluation unit receives a current value for the sound velocity of the medium flowing in the measuring tube, that the control and evaluation unit changes the ultrasonic signal frequency of the emitted ultrasonic signal to a current value of the ultrasonic signal frequency when the received current value of the sound velocity is changed with respect to the defined value of the sound velocity of the medium, so that a change in the opening angle of the sound beam of the ultrasonic signal caused by the change in the value of the sound velocity of the medium is at least partially compensated. The measure described can counteract an undesired change in the opening angle of the sound beam of the ultrasonic signal so that the desired measurement quality can be maintained.

The ultrasonic signal frequency of the emitted ultrasonic signal can be changed such that the opening angle of the sound beam of the emitted ultrasonic signal remains within a tolerance range around a nominal opening angle. It is taken into account here that it is often not necessary to set the opening angle of the sound beam of the ultrasonic signal exactly, but that certain deviations are acceptable.

The ultrasonic signal frequency can be changed in frequency steps to the changed, current value of the ultrasonic signal frequency, in particular wherein the change to the changed value of the ultrasonic signal frequency causes a jump from one tolerance limit of the tolerance range to the other tolerance limit of the tolerance range. In this further development of the method, not every change in the sound velocity of the medium also leads to a change in the emitted ultrasonic signal frequency; instead, a change in the excitation frequency is waited for until a tolerance range is exceeded. This is useful, for example, if the emitting ultrasonic transducer is only to be operated at a few different frequencies, for example because advantageous excitation is only possible at these determined frequencies (resonances, utilization of radial and axial excitation modes).

The ultrasonic signal frequency can also be continuously changed to the changed current value of the ultrasonic signal frequency. This is particularly suitable if the current value for the sound velocity of the medium is frequently updated or is frequently made available and a fine-grained change in the ultrasonic signal frequency is unproblematic.

In an example, the ultrasonic signal frequency of the emitted ultrasonic signal may only be changed when the change in the received current sound velocity compared to the known sound velocity of the medium exceeds a predetermined change threshold value. Since the opening angle of the sound beam of the ultrasonic signal changes depending on the sound velocity in the medium, the change in sound velocity can also be used directly to adjust the ultrasonic signal frequency accordingly.

The current value for the sound velocity of the medium flowing in the measuring tube can be calculated by the control and evaluation unit itself on the basis of a transit time measurement of the emitted ultrasonic signal and a known length of the emitted ultrasonic signal. This is particularly easy if the ultrasonic flowmeter is set up to perform a transit time difference measurement in which the signal transit times are measured in both the flow direction and the opposite direction, since the flow velocity of the medium is automatically eliminated during the calculation when the transit times are appropriately summed.

The current value for the sound velocity of the medium flowing in the measuring tube may be specified, in particular by an external parameter input. The current value for the sound velocity can, for example, be determined by an external measuring process, wherein the determined value is distributed by a control computer to ultrasonic flowmeters operating according to the invention.

The required change in the value of the ultrasonic signal frequency to the current value of the ultrasonic signal frequency for compensating the influence of the change in the sound velocity in the medium on the opening angle of the sound beam can be calculated on the basis of a physical-mathematical model of wave propagation. In particular, an equation is used to describe the sound pressure in dependence on a polar angle with respect to a main radiation direction of the emitting ultrasonic transducer. In general, a wave equation for sound waves is solved, taking into account the geometric and physical boundary conditions (ultrasonic transducer, medium). From the physical-mathematical model, the dependence of the opening angle of the sound beam on the sound velocity of the medium and the ultrasonic signal frequency of the excited ultrasonic signal is determined analytically or numerically. The required change in the ultrasonic signal frequency is determined from the dependence between the opening angle, the sound velocity and the ultrasonic signal frequency, in order to at least partially compensate for the influence of the changed sound velocity on the opening angle of the ultrasonic signal.

The derived object is also achieved with the ultrasonic flowmeter described above, wherein the control and evaluation unit carries out the method described in detail above during operation of the ultrasonic flowmeter.

Further scope of applicability of the present invention will become apparent from the detailed description given hereinafter. However, it should be understood that the detailed description and specific examples, while indicating preferred embodiments of the invention, are given by way of illustration only, since various changes, combinations, and modifications within the spirit and scope of the invention will become apparent to those skilled in the art from this detailed description.

### BRIEF DESCRIPTION OF THE DRAWINGS

The present invention will become more fully understood from the detailed description given hereinbelow and the accompanying drawings which are given by way of illustration only, and thus, are not limitive of the present invention, and wherein:

FIG. 1 shows schematically, a method for operating an ultrasonic flowmeter and an ultrasonic flowmeter on which the method is operated, wherein an ultrasonic signal is emitted with a sound beam at an opening angle,

FIGS. 2a, 2b shows schematically, a method for operating an ultrasonic flowmeter and an ultrasonic flowmeter to illustrate the influence of a changing sound velocity in the medium,

FIG. 3 shows schematically, the method for operating an ultrasonic flowmeter and the corresponding ultrasonic flowmeter with compensation of a change in the opening angle of the sound beam due to a changing sound velocity in the medium,

FIG. 4 shows schematically, the method for operating an ultrasonic flowmeter showing the polar angle dependency of the sound pressure in the far field of a ultrasonic transducer with a cylindrical form,

FIG. 5 shows schematically, the method for operating an ultrasonic flowmeter with a representation of the dependence of the opening angle of the sound beam of a cylindrical ultrasonic transducer on the sound velocity in the medium and on the ultrasonic signal frequency, and

FIG. 6 shows schematically, the method for operating an ultrasonic flowmeter according to FIG. 5 and a strategy for changing the ultrasonic signal frequency in response to a changing sound velocity in the medium.

### DETAILED DESCRIPTION

The figures schematically show various aspects of a method 1 for operating an ultrasonic flowmeter 2 for measuring the flow through a measuring tube 4 through which a medium 3 flows.

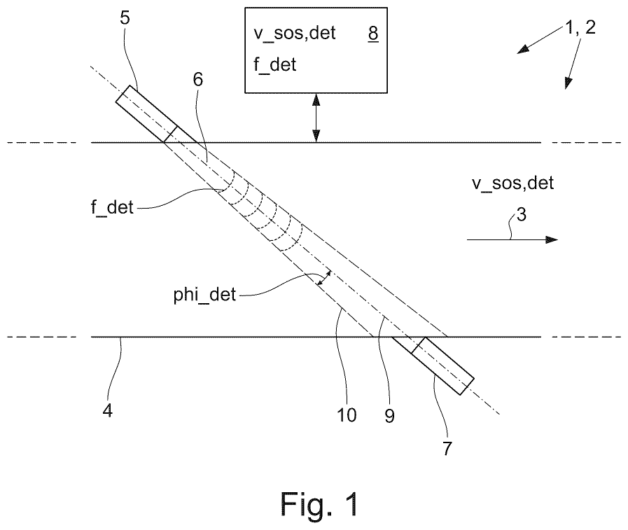

FIG. 1 shows the ultrasonic flowmeter 2 on which the method 1 is operated during operation. The ultrasonic flowmeter 2 comprises an emitting ultrasonic transducer 5 for emitting ultrasonic signals 6 and a receiving ultrasonic transducer 7 for receiving the ultrasonic signals 6. Furthermore, the ultrasonic flowmeter 2 also includes a control and evaluation unit 8. The ultrasonic transducers 5, 7 are arranged in such a way that they implement an ultrasonic measuring path 9 in the medium 3. The control and evaluation unit 8 controls the emitting ultrasonic transducer 5 so that it emits the ultrasonic signal 6, the receiving ultrasonic transducer 7 receives the emitted ultrasound signal and the control and evaluation unit 8 determines a value for the flow of the medium 3 through the measuring tube 4 by evaluating the emitted and received ultrasonic signals 6.

In the example, the control and evaluation unit 8 implements a transit time difference measurement, i.e. the signal transit times of the ultrasonic signal 6 in the direction of flow and against the direction of flow are measured and a flow velocity is determined therefrom, which allows a conclusion to be drawn about the volume flow rate of the medium 3. FIG. 1 shows that the ultrasonic signal 6 is emitted in the direction of flow, i.e. from left to right, by the emitting ultrasonic transducer 5. However, due to the transit time difference measurement, the ultrasonic transducers 5, 7 can also act alternately as the emitting ultrasonic transducer 5 and the receiving ultrasonic transducer 7. The double arrow between the control and evaluation unit 8 indicates that the control and evaluation unit 8 is functionally connected to the other components of the ultrasonic flowmeter 2, in particular to its ultrasonic transducers 5, 7, for the purpose of performing the flow measurement.

In the ultrasonic flowmeter according to FIG. 1, the emitting ultrasonic transducer 5 is controlled by the control and evaluation unit 8 in such a way that the ultrasonic transducer 5 emits ultrasonic signals 6 at a defined ultrasonic signal frequency f_det. If the medium 3 has a defined value of the sound velocity v_sos,det of the medium 3 flowing in the measuring tube 4, then the ultrasonic signal 6 is emitted with a defined opening angle of a sound beam 10 of the ultrasonic signal 6. The defined values mentioned are the values on which the factory calibration of the ultrasonic flowmeter 2 is based.

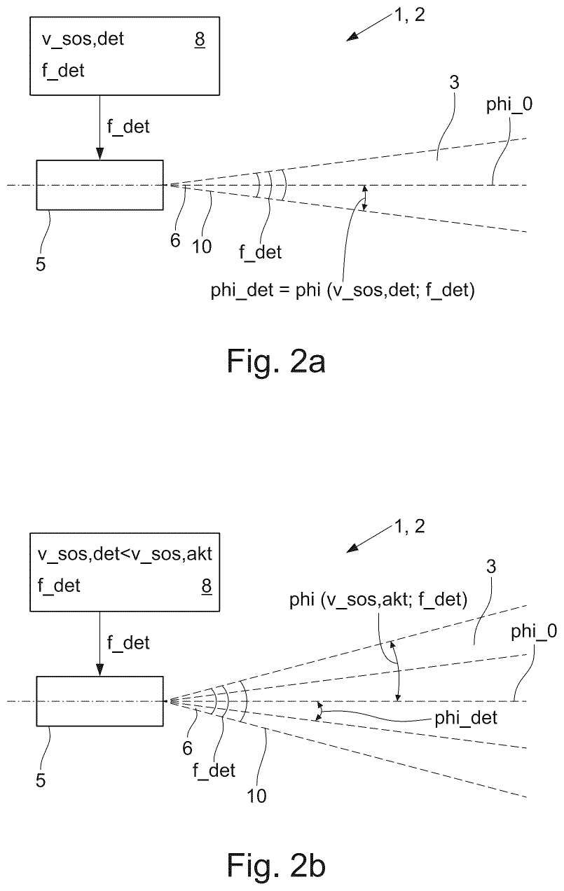

In the context of flow measurement of gaseous media 3, it has been recognized that gases of very different densities, whose gas molecules have very different molar masses, have a significant influence on the sound velocity in the medium 3 and thus also on the opening angle phi of the sound beam 10, with which the ultrasonic signals 6 are emitted into the medium 3; this is demonstrated in more detail in FIG. 2.

FIG. 2a shows the conditions for the flow measurement when the defined values for the ultrasonic signal frequency f_det and for the sound velocity v_sos,det are present in the medium 3 flowing through the measuring tube 4. Under these conditions, the ultrasonic signal 6 is emitted with an sound beam 10 with the defined opening angle phi_det. The opening angle phi of the sound beam 10 depends on the sound velocity v_sos in the medium 3, which here, according to the conditions, corresponds to the defined value v_sos,det of the sound velocity, and the ultrasonic signal frequency f, which here, according to the conditions, corresponds to the defined ultrasonic signal frequency f_det. Accordingly, the following relationship applies: phi_det=phi (v_sos,det; f_det).

FIG. 2b shows that the medium 3 has changed insofar as it has a current sound velocity v_sos,akt, which differs from the defined value v_sos,det of the sound velocity of the medium 3, the sound velocity v_sos,akt is greater than the defined value v_sos,det of the sound velocity. If the defined ultrasonic signal frequency is maintained at the value f_det, the opening angle phi (v_sos,akt; f_det) of the sound beam 6 with which the ultrasonic signal is emitted into the medium 3 increases compared to the opening angle phi_det. This can have undesirable effects on the quality of the measurement, as the signal-to-noise ratio decreases and mutual interference occurs from several neighboring ultrasonic transducer pairs, which are arranged adjacent to one another and define several measurement paths.

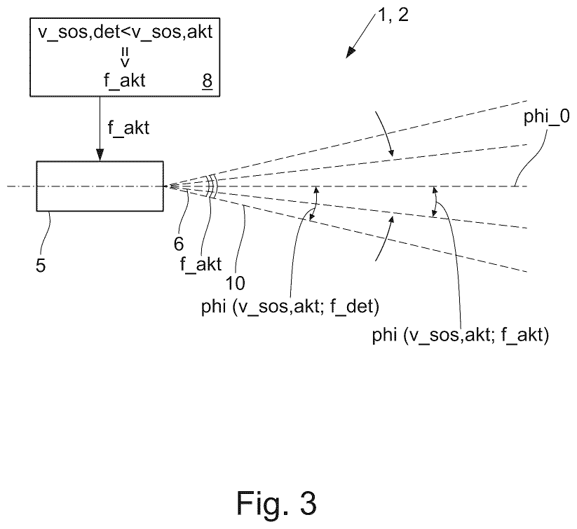

FIG. 3 shows method 1 and the ultrasonic flowmeter 2, in which a countermeasure is taken to compensate for the increased opening angle phi caused by the changed sound velocity v_sos,akt. The control and evaluation unit 8 receives the current value v_sos,akt for the sound velocity of the medium 3 flowing in the measuring tube 4, and the control and evaluation unit 8 changes the ultrasonic signal frequency f of the emitted ultrasonic signal 6 to a current value f_akt of the ultrasonic signal frequency in the event of the present change in the current value v_sos,akt of the sound velocity in relation to the defined value v_sos,det of the sound velocity of the medium 3, so that a change in the opening angle phi of the sound beam 10 of the ultrasonic signal 6 caused by the change in the value of the sound velocity of the medium 3 is at least partially compensated. The opening angle phi changes as a result of the measure on the re-reduced opening angle phi (v_sos,akt; f_akt).

In the illustrated method 1, the required change in the value of the ultrasonic signal frequency f to the current value f_akt of the ultrasonic signal frequency f for compensating the influence of the change in the sound velocity v_sos in the medium 3 on the opening angle phi of the sound beam 10 of the ultrasonic signal 6 is calculated on the basis of a physical-mathematical model of wave propagation. The method is based on the law that applies to ideal gases, according to which the speed of sound in a gaseous medium is inversely proportional to the square root of the molar mass of the gas (in addition to the temperature dependency):

$$v\_sos = \sqrt{\frac{γ RT}{M}}$$

Furthermore, an equation is used to describe the far field of the sound pressure p of a cylindrical ultrasonic transducer 5 in dependence on a polar angle phi with respect to a main radiation direction phi_0 of the emitting ultrasonic transducer 5 as a physical-mathematical model of the wave propagation:

$$p ( r , phi , t ) = \frac{j}{2} ρ cU \frac{a}{r} ka [ \frac{2 J 1 ( ka sin ( phi ) )}{ka sin ( phi )} ] {e}^{j ( wt - kr )}$$

Here, the angle phi has the meaning of the angle phi given in the figures and corresponds to the polar angle measured from the main radiation direction phi_0 of the emitting ultrasonic transducer 5. The equation has the usual form of an acoustic wave equation in spherical coordinates, starting from a cylindrical form of the ultrasonic transducer 5.

The dependence of the sound pressure p on the polar angle phi, which is of interest, is given only by the term in square brackets. J1 is the Bessel function of the first kind and first order, k is the wave number and a is the radius of the cylindrical ultrasonic transducer 5.

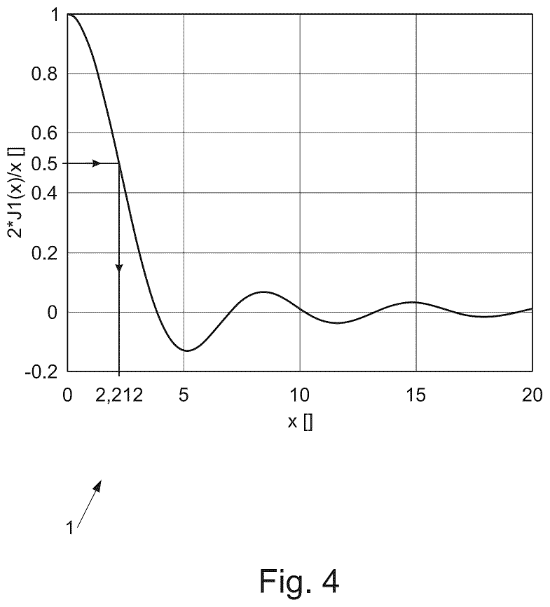

FIG. 4 shows the term in brackets in dependence on the argument x=k*a*sin (phi). The sound beam 10 is defined by a sound pressure drop of −6 dB compared to the sound pressure in the main radiation direction phi_0. This attenuation corresponds to a pressure drop by half for a power root size such as the sound pressure p. The value 0.5 for the term in brackets is reached for x=2.212.

Since k=2*pi*f/v_sos and a=D/2, wherein D is the diameter of the ultrasonic transducer, the following applies:

$$phi = arcsin [ \frac{Kd * {v}_{sos}}{D * f} ]$$

$$where Kd = x / pi = 0.70 .$$

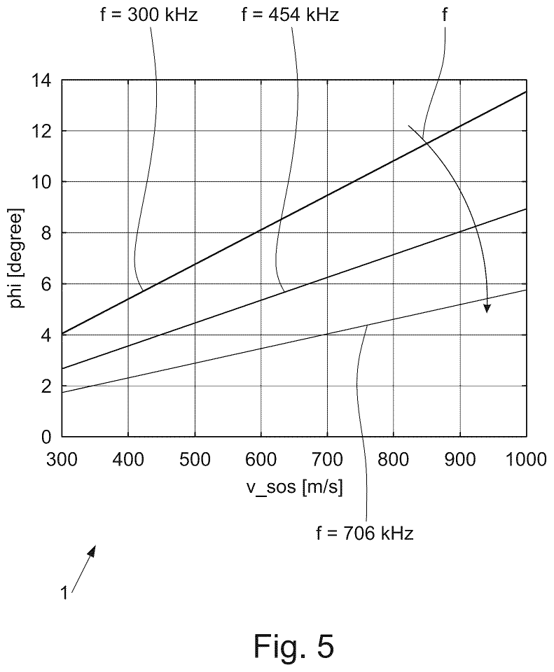

Based on this relationship, FIG. 5 shows the dependence of the opening angle phi of the sound beam 10 (defined by the drop in sound pressure by −6 dB) on the sound velocity v_sos in the medium 3, which in turn depends on the molar mass M of the gas molecules, for an ultrasonic transducer 5 with a diameter of D=10 mm.

The three curves correspond to different specifications for the ultrasonic signal frequency f, namely for the values f=300 kHz, f=454 kHz and f=706 kHz, so they are parameter lines in the ultrasonic signal frequency f. It can be clearly seen how the opening angle phi of the sound beam 10 of the ultrasonic signal 6 can be influenced by changing the ultrasonic signal frequency f. It is therefore possible to counteract a change in the opening angle phi of the sound beam 10 of the ultrasonic signal 6 caused by a change in the sound velocity v_sos of the medium 3 by a corresponding change in the ultrasonic signal frequency f of the ultrasonic signal 6.

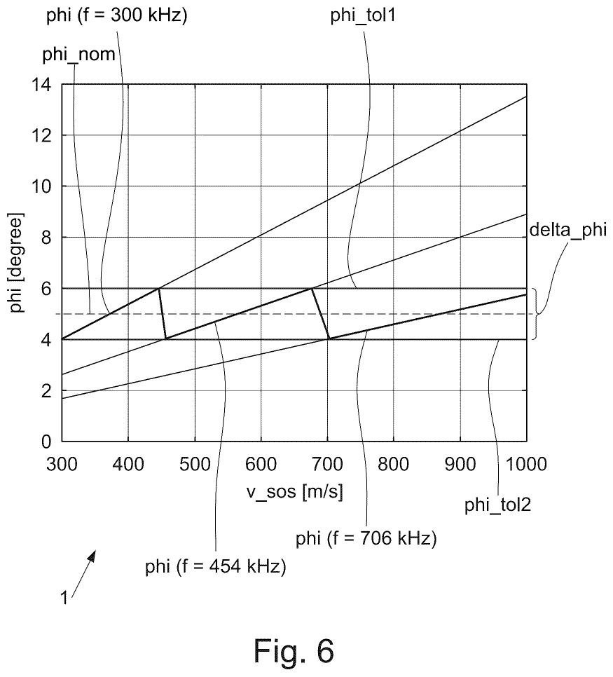

FIG. 6 shows an implemented concept for changing the ultrasonic signal frequency f to compensate for a change in the opening angle phi of the sound beam 10 of the ultrasonic signal 6. Here it is implemented that the ultrasonic signal frequency f of the emitted ultrasonic signal 6 is changed in such a way that the opening angle phi of the sound beam 10 of the emitted ultrasonic signal 6 remains within a tolerance range delta_phi around a nominal opening angle phi_nom of 5°.

The ultrasonic signal frequency f is changed in frequency steps to the changed current value f_akt of the ultrasonic signal frequency, wherein the change to the changed value f_akt of the ultrasonic signal frequency jumps from one tolerance limit phi_tol1 (6°) of the tolerance range delta_phi to the other tolerance limit phi_tol2 (4°) of the tolerance range delta_phi. This means that not every change in the sound velocity v_sos of the medium also leads to a change in the frequency of the excited ultrasonic signal 6.

In an example method 1, the ultrasonic signal frequency f can be continuously changed to the changed current value f_akt of the ultrasonic signal frequency f.

In the method 1 and the ultrasonic flowmeter 2 shown, the current value v_sos,akt for the sound velocity v_sos of the medium 3 flowing in the measuring tube 4 is calculated by the control and evaluation unit 8 itself on the basis of a transit time measurement of the emitted ultrasonic signal 6 and a known length of the emitted ultrasonic signal 6.

The invention being thus described, it will be obvious that the same may be varied in many ways. Such variations are not to be regarded as a departure from the spirit and scope of the invention, and all such modifications as would be obvious to one skilled in the art are to be included within the scope of the following claims.

What is claimed is:

1. A method for operating an ultrasonic flowmeter for measuring a flow through a measuring tube through which a medium is adapted to flow, the ultrasonic flowmeter comprises at least one emitting ultrasonic transducer for transmitting ultrasonic signals and at least one receiving ultrasonic transducer for receiving ultrasonic signals, and comprises a control and evaluation unit, the at least one emitting and receiving ultrasonic transducers being arranged such that they implement an ultrasonic measuring path in the medium, the method comprising:
actuating, via the control and evaluation unit, the emitting ultrasonic transducer such that it emits the ultrasonic signal, and such that the receiving ultrasonic transducer receives the emitted ultrasonic signal;
determining, via the control and evaluation unit, at least one indirect value for the flow rate of the medium through the measuring tube by evaluating emitted and received ultrasonic signals;
controlling, via the control and evaluation unit, the emitting ultrasonic transducer such that the emitted ultrasonic signal is emitted at a defined ultrasonic signal frequency, so that at a defined value of the sound velocity of the medium flowing in the measuring tube, the ultrasonic signal is emitted with a defined opening angle of an sound beam of the ultrasonic signal;
receiving, by the control and evaluation unit, a current value for a speed of sound of the medium flowing in the measuring tube; and
changing via the control and evaluation unit, in an event of a change in the current value of the sound velocity obtained with respect to the defined value of the sound velocity of the medium, the ultrasonic signal frequency of the emitted ultrasonic signal to a current value of the ultrasonic signal frequency, so that a change in the opening angle of the sound beam of the ultrasonic signal caused by the change in the value of the sound velocity of the medium is at least partially compensated.

2. The method according to claim 1, wherein the ultrasonic signal frequency of the emitted ultrasonic signal is changed such that the opening angle of the sound beam of the emitted ultrasonic signal remains within a tolerance range around a nominal opening angle.

3. The method according to claim 1, wherein the ultrasonic signal frequency is changed in frequency steps to the changed current value of the ultrasonic signal frequency, or wherein, as a result of the change to the changed value of the ultrasonic signal frequency, a jump is made from one tolerance limit of the tolerance range to the other tolerance limit of the tolerance range.

4. The method according to claim 1, wherein the ultrasonic signal frequency is continuously changed to the changed current value of the ultrasonic signal frequency.

5. The method according to claim 1, wherein the ultrasonic signal frequency of the emitted ultrasonic signal is only changed when the change in the obtained sound velocity with respect to the defined sound velocity of the medium exceeds a predetermined change threshold.

6. The method according to claim 1, wherein the current value for the sound velocity of the medium flowing in the measuring tube is calculated by the control and evaluation unit itself on based on a transit time measurement of the emitted ultrasonic signal and a known length of the emitted ultrasonic signa.

7. The method according to claim 1, wherein the current value for the sound velocity of the medium flowing in the measuring tube is specified or is specified by an external parameter input.

8. The method according to claim 1, wherein the required change in the value of the ultrasonic signal frequency to the current value of the ultrasonic signal frequency for compensating for the influence of the change in the sound velocity in the medium on the opening angle of the ultrasonic signal is calculated on the basis of a physical-mathematical model of wave propagation, in particular by using an equation for describing the sound pressure as a function of a polar angle with respect to a main radiation direction of the emitting ultrasonic transducer.

9. An ultrasonic flowmeter to measure the flow rate through a measuring tube through which a medium is adapted to flow, the ultrasonic flow meter comprising:
at least one emitting ultrasonic transducer for transmitting ultrasonic signals; and
at least one receiving ultrasonic transducer for receiving ultrasonic signals, the at least one emitting a receiving ultrasonic transducers being arranged such that they implement an ultrasonic measuring path in the medium; and
a control and evaluation unit that controls the emitting ultrasonic transducer such that it emits an ultrasonic signal, the receiving ultrasonic transducer being adapted to receive the emitted ultrasonic signal and the control and evaluation unit controlling the receiving ultrasonic transducer by evaluating emitted ultrasonic signals and received ultrasonic signals, the control and evaluation unit determining at least one indirect value for the flow rate of the medium through the measuring tube by evaluating emitted ultrasonic signals and received ultrasonic signals,
wherein, during operation of the ultrasonic flowmeter, the control and evaluation unit controls the emitting ultrasonic transducer such that the emitted ultrasonic signal is emitted at a defined ultrasonic signal frequency so that at a defined value of the sound velocity of the medium flowing in the measuring tube, the ultrasonic signal is emitted at a defined opening angle of a sound beam of the ultrasonic signal,
wherein the control and evaluation unit obtains a current value for the sound velocity of the medium flowing in the measuring tube, and
wherein the control and evaluation unit, upon a change of the obtained current value of the sound velocity with respect to the defined value of the sound velocity of the medium, changes the ultrasonic signal frequency of the emitted ultrasonic signal to a current value of the ultrasonic signal frequency so that a change in the opening angle of the sound beam of the ultrasonic signal caused by the change in the value of the sound velocity of the medium is at least partially compensated.

10. The ultrasonic flowmeter according to claim 9, wherein the control and evaluation unit carries out a method during operation of the ultrasonic flowmeter, the method comprising:
actuating, via the control and evaluation unit, the emitting ultrasonic transducer such that it emits the ultrasonic signal, and such that the receiving ultrasonic transducer receives the emitted ultrasonic signal;
determining, via the control and evaluation unit, at least one indirect value for the flow rate of the medium through the measuring tube by evaluating emitted and received ultrasonic signals;
controlling, via the control and evaluation unit, the emitting ultrasonic transducer such that the emitted ultrasonic signal is emitted at a defined ultrasonic signal frequency, so that at a defined value of the sound velocity of the medium flowing in the measuring tube, the ultrasonic signal is emitted with a defined opening angle of an sound beam of the ultrasonic signal;
receiving, by the control and evaluation unit, a current value for a speed of sound of the medium flowing in the measuring tube; and
changing via the control and evaluation unit, in an event of a change in the current value of the sound velocity obtained with respect to the defined value of the sound velocity of the medium, the ultrasonic signal frequency of the emitted ultrasonic signal to a current value of the ultrasonic signal frequency, so that a change in the opening angle of the sound beam of the ultrasonic signal caused by the change in the value of the sound velocity of the medium is at least partially compensated.
